(19) United States
(12) Patent Application Publication
(10) Pub. No.: US 2002/0150736 A1
(43) Pub. Date: Oct. 17, 2002

(54) Ink jet recording medium

(76) Inventors: Dirk Quintens, Westerlo (BE); Horst Friedel, Neu-Isenburg (DE)

Correspondence Address: Joseph T. Guy Ph.D., Nexsen Pruet Jacobs & Pollard LLP, 201 W. McBee Avenue, Greenville, SC, 29603, US

(21) Appl. No.: 10/085,744

(22) Filed: Oct. 22, 2001

(30) Foreign Application Priority Data
Nov. 30, 2000 (EP) 00204257.0

(51) Int. Cl. B41J 3/407; B32B 3/00

(52) U.S. Cl. 428/195; 347/106; 428/206

(57) ABSTRACT

An ink jet recording element is disclosed which is improved for the occurence of cracks in its ink-receiving layer. The recording medium comprises a layer with a high amount of pigment and a top layer containing a water-soluble polymer. Both layers are coated simultaneously wet on wet.

The application claims the benefit of Provisional Application No. 60/256,543 filed Dec. 18, 2000.

### FIELD OF THE INVENTION

The present invention relates to an improved recording medium for ink jet printing.

### BACKGROUND OF THE INVENTION

In the majority of applications printing proceeds by pressure contact of an ink-loaden printing form with an ink-receiving material which is usually plain paper. The most frequently used impact printing technique is known as lithographic printing based on the selective acceptance of oleophilic ink on a suitable receptor.

In recent times however so-called non-impact printing systems have replaced classical pressure-contact printing to some extent for specific applications. A survey is given e.g. in the book “Principles of Non Impact Printing” by Jerome L. Johnson (1986), Palatino Press, Irvine, Calif. 92715, USA.

Among non-impact printing techniques ink jet printing has become a popular technique because of its simplicity, convenience and low cost. Especially in those instances where a limited edition of the printed matter is needed ink jet printing has become a technology of choice. A recent survey on progress and trends in ink jet printing technology is given by Hue P. Le in Journal of Imaging Science and Technology Vol. 42 (1), January/February 1998.

In ink jet printing tiny drops of ink fluid are projected directly onto an ink receptor surface without physical contact between the printing device and the receptor. The printing device stores the printing data electronically and controls a mechanism for ejecting the drops image-wise. Printing is accomplished by moving the print head across the paper or vice versa. Early patents on ink jet printers include U.S. Pat. No. 3,739,393, U.S. Pat. No. 3,805,273 and U.S. Pat. No. 3,891,121.

The jetting of the ink droplets can be performed in several different ways. In a first type of process a continuous droplet stream is created by applying a pressure wave pattern. This process is known as continuous ink jet printing. In a first embodiment the droplet stream is divided into droplets that are electrostatically charged, deflected and recollected, and into droplets that remain uncharged, continue their way undeflected, and form the image. Alternatively, the charged deflected stream forms the image and the uncharged undeflected jet is recollected. In this variant of continuous ink jet printing several jets are deflected to a different degree and thus record the image (multideflection system).

According to a second process the ink droplets can be created “on demand” (“DOD” or “drop on demand” method) whereby the printing device ejects the droplets only when they are used in imaging on a receiver thereby avoiding the complexity of drop charging, deflection hardware, and ink recollection. In drop-on-demand the ink droplet can be formed by means of a pressure wave created by a mechanical motion of a piezoelectric transducer (so-called “piezo method”), or by means of discrete thermal pushes (so-called “bubble jet” method, or “thermal jet” method).

Ink compositions for ink jet typically include following ingredients: dyes or pigments, water and/or organic solvents, humectants such as glycols, detergents, thickeners, polymeric binders, preservatives, etc. It will be readily understood that the optimal composition of such an ink is dependent on the ink jetting method used and on the nature of the substrate to be printed. The ink compositions can be roughly divided in:

water based; the drying mechanism involves absorption, penetration and evaporation;

oil based; the drying involves absorption and penetration;

solvent based; the drying mechanism involves primarely evaporation;

hot melt or phase change: the ink vehicle is liquid at the ejection temperature but solid at room temperature; drying is replaced by solidification;

UV-curable; drying is replaced by polymerization.

It is known that the ink-receiving layers in ink-jet recording elements must meet different stringent requirements:

The ink-receiving layer should have a high ink absorbing capacity, so that the dots will not flow out and will not be expanded more than is necessary to obtain a high optical density.

The ink-receiving layer should have a high ink absorbing speed (short ink drying time) so that the ink droplets will not feather if smeared immediately after applying.

The ink dots that are applied to the ink-receiving layer should be substantially round in shape and smooth at their peripheries. The dot diameter must be constant and accurately controlled.

The receiving layer must be readily wetted so that there is no “puddling”, i.e. coalescence of adjacent ink dots, and an earlier absorbed ink drop should not show any “bleeding”, i.e. overlap with neighbouring or later placed dots.

Transparent ink-jet recording elements must have a low haze-value and be excellent in transmittance properties.

After being printed the image must have a good resistance regarding water-fastness, light-fastness, and good endurance under severe conditions of temperature and humidity.

The ink jet recording element may not show any curl or sticky behaviour if stacked before or after being printed.

The ink jet recording element must be able to move smoothly through different types of printers.

All these properties are often in a relation of trade-off. It is difficult to satisfy them all at the same time.

It is known that the presence in the ink accepting layer of absorptive pigments such as silica, kaolin, talc, aluminum oxide, boehmite, etc. improve the absorption capacity, the obtainable colour density and the drying time. Many patent applications have described this effect for many different binder-systems. U.S. Pat. No. 3,357,846 describes pigments such as kaolin, talc, bariet, TiO₂ used in starch and PVA. U.S. Pat. No. 3,889,270 describes silica in gelatin, PVA and cellulose. Pigments and particles have also been described in patent applications including DE 2,925,769, GB 2,050,866, U.S. Pat. No. 4,474,850, U.S. Pat. No. 4,547,405, U.S. Pat. No. 4,578,285, WO 88 06532, U.S. Pat. No. 4,849,286, EP 339604, EP 400681, EP 407881, EP 411638 and U.S. Pat. No. 5,045,864 (non-exhaustive list).

These particulates are dispersed in various types of binders of which the most common types such as gelatin, polyvinyl alcohol, polyvinyl pyrrolidone, and various types of cellulose derivatives. These conventional binders are mentioned in numerous patent documents.

It is further known to use various types of film-forming polymers to improve the waterfastness of the coated ink receiving layer by increasing its adhesion to the support.

It is also known to improve the waterfastness of the finished printed image by the incorporation of mordanting polymers bearing cationic quaternary groups such as ammonium-, sulphonium and phosphonium groups. These polymers interact with most typical ink jet inks resulting in a better anchoring of the dye in the binder. Typical examples of such descriptions are U.S. Pat. No. 4,371,582, U.S. Pat. No. 4,575,465, U.S. Pat. No. 4,649,064, GB 2 210 071 and EP 423829.

In order to provide for sufficient ink absorptivity it is useful to incorporate rather high amounts of a pigment, e.g. an inorganic pigment such as silica, in the ink accepting layer. Concentrations of above 60%, expressed as solid weight % are highly desirable. However, such highly packed pigmented layers show the drawback to develop cracks after coating and drying. Such a cracked layer is visually strongly disturbing, especially after printing the medium by ink jet. Therefore there is a strong need for a solution to this cracking problem.

### OBJECTS OF THE INVENTION

It is an object of the present invention to provide a method for the preparation of an ink jet recording medium that is improved for the occurence of cracking.

It is a further object of the present invention to provide a method for the preparation of an ink jet recording medium with high absorptivity for ink.

### SUMMARY OF THE INVENTION

The above mentioned objects are realised by providing a method for the preparation of an ink jet recording element comprising coating on top of a support a layer pack comprising, in order, (a) a layer containing a pigment at a solid weight % of 60 to 98 of the total solid weight of the layer, and (b) a layer containing a water-soluble polymer, characterized in that said layers (a) and (b) are coated simultaneously wet on wet.

### DETAILED DESCRIPTION OF THE INVENTION

It is the essence of the present invention that a top layer (b) containing a water-soluble polymer must be present on top of the pigment containing layer, and that both layers must be coated simultaneously wet on wet. When there is no top layer (b) or said layer contains a water-insoluble polymer, e.g. in dispersed form or in the form of a latex, the problem of the occurence of cracks will not be solved.

Typical water-soluble polymers for use in top layer (b) include hydroxyethyl cellulose; hydroxypropyl cellulose; hydroxyethylmethyl cellulose; hydroxypropyl methyl cellulose; hydroxybutylmethyl cellulose; methyl cellulose; sodium carboxymethyl cellulose; sodium carboxymethylhydroxethyl cellulose; water soluble ethylhydroxyethyl cellulose; cellulose sulfate; polyvinyl alcohol; vinylalcohol copolymers; polyvinylacetal; polyvinyl pyrrolidone; acrylamide/acrylic acid copolymer; styrene/acrylic acid copolymer; vinyl methyl ether/maleic acid copolymer; poly(2-acrylamido-2-methyl propane sulfonic acid); poly(diethylene triamine-co-adipic acid); polyvinyl pyridine; polyvinyl imidazole; polyimidazoline quaternized; polyethylene imine epichlorohydrin modified; polyethylene imine ethoxylated; poly(N,N-dimethyl-3,5-dimethylene piperidinium chloride; polyethylene oxide; polyurethane; melamine resins; gelatin; carrageenan; dextran; gum arabic; casein; pectin; albumin; starch; collagen derivatives; collodion and agar-agar.

Especially preferred water-soluble polymers for use in accordance with the present invention are cationic polymers, most preferably N-containing cationic polymers. A particularly suited compound is a poly(diallyldimethylammonium chloride) or, in short, a poly(dadmac). These compounds are commercially available from several companies, e.g. Aldrich, Calgon, Clariant, BASF, EKA Chemicals, and Nippon Goshei. A preferred type is GOHSEFIMER K210, trade name of Nippon Goshei Co.

Other useful cationic compounds include dadmac copolymers such as copolymers with acrylamide; dimethylamine-epichlorohydrine copolymers, e.g. POLYFIX 700, trade name of Showa High Polymer Co. other Polyfix grades which could be used are POLYFIX 601, POLYFIX 301, POLYFIX 301A, POLYFIX 250WS, and POLYFIX 3000; NEOFIX E-117, trade name of Nicca Chemical Co., a polyoxyalkylene polyamine dicyanodiamine; REDIFLOC 4150, trade name of EKA Chemicals, a polyamine; MADAME (methacrylatedimethylaminoethyl=dimethylaminoethyl methacrylate) or MADQUAT (methacryloxyethyltrimethylammonium chloride) modified polymers, e.g. ROHAGIT KL280, ROHAGIT 210, ROHAGIT SL144, PLEX 4739L, PLEX 3073 from Röhm, DIAFLOC KP155 and other DIAFLOC products from Diafloc Co., and BMB 1305 and other BMB products from EKA chemicals; cationic epichlorohydrin adducts such as POLYCUP 171 and POLYCUP 172, trade names from Hercules Co.; from Cytec industries: CYPRO products, e.g. CYPRO 514/515/516, SUPERFLOC 507/521/567; cationic cellulose derivatives such as CELQUAT L-200, H-100, SC-240C, SC-230M, trade names of Starch & Chemical Co., and QUATRISOFT LM200, UCARE polymers JR125, JR400, LR400, JR30M, LR30M and UCARE polymer LK; fixing agents from Chukyo Europe: PALSET JK-512, PALSET JK512L, PALSET JK-182, PALSET JK-220, WSC-173, WSC-173L, PALSET JK-320, PALSET JK-320L and PALSET JK-350; polyethyleneimine and copolymers, e.g. LUPASOL, trade name of BASF AG; triethanolamine-titanium-chelate, e.g. TYZOR, trade name of Du Pont Co.; copolymers of vinylpyrrolidone such as VIVIPRINT 111, trade name of ISP, a methacrylamido propyl dimethylamine copolymer; with dimethylaminoethylmethacrylate such as COPOLYMER 845 and COPOLYMER 937, trade names of ISP; with vinylimidazole, e.g. LUVIQUAT CARE, LUVITEC 73W, LUVITEC VPI55 K18P, LUVITEC VP155 K72W, LUVIQUAT FC905, LUVIQUAT FC550, LUVIQUAT HM522, and SOKALAN HP56, all trade names of BASF AG; polyamidoamines, e.g. RETAMINOL and NADAVIN, trade marks of Bayer AG; and phosphonium compounds such as disclosed in EP 609930. Still other cationic compounds include gelatin when the layer pH is below the isoelectric point of the gelatin, cationic aluminum oxide, boehmite, and poly(aluminumhydroxychloride) such as SYLOJET A200, trade name of Grace Co. Still further cationic polymers include polyvinylamines, e.g. PVAM-0595B from Esprit Co., and cationic modified acrylics, e.g. ACRIT RKW319SX, trade name of Tasei Chemical Industries, and RD134 from Goo Chemical.

The top layer (b) is a rather thin layer compared to the pigment containing layer (a). Its wet thickness is preferably comprised between 1 μm and 60 μm, most preferably between 10 and 40 μm.

The pigment containing layer (a) according to the present invention contains a rather high amount of pigment ranging from 60 to 98 solid weight % of the total solid weight of the layer. The pigment may be chosen from organic material such as polystyrene, polymethylmethacrylate, silicones, urea-formaldehyde condensation polymers, polyesters and polyamides. Preferably however, it is an inorganic porous pigment, such as silica, talc, clay, koalin, diatomaceous earth, calcium carbonate, magnesium carbonate, aluminium hydroxide, aluminium oxide, titanium oxide, zinc oxide, barium sulfate, calcium sulfate, zinc sulfide, satin white, boehmite and pseudo-boehmite.

The preferred pigment is a silica type, more particularly an amorphous silica having a average particle size ranging from 1 μm to 15 μm, most preferably from 2 to 10 μm. The use of non-colloidal silica types in ink jet receiver formulations is known for long time, e.g. from old references such as JP-A 55-051583, JP-A 56-000157, U.S. Pat. No. 4,474,850 and DE 3410828. Also finer silica types or colloidal silica may be used.

The bulk layer (a) may contain as binder a water-soluble polymer chosen from the same list as given above for the top layer (b). Furtheron, it can contain water-insoluble polymers in the form of dispersions or in the form of latices. Representative polymers (water-soluble and water-insoluble) include conjugated diene polymers such as styrene-butadiene copolymers and methyl methacrylate-butadiene copolymers, acrylic polymers, for example, homopolymers and copolymers of acrylic acid esters and methacrylic acid esters, vinyl polymers, e.g. butadiene-acrylonitrile copolymers, and polyurethane or urethane/acrylic hybrids; vinylester polymers, for example, polyvinyl acetate, ethylene-vinyl acetate copolymers; vinylacetate-acrylate copolymers, vinylacetate-maleate copolymers, and modification reaction products of the above-mentioned polymers and copolymers, for example, modified with a carboxyl and/or cationic groups; water-soluble or dispersible resins, for example, melamine-formaldehyde resins and urea-formaldehyde resins; water-insoluble adhesive resins, for example, maleic anhydride copolymer resins, polyacrylamide resins, polymethyl methacrylate resins, polyurethane resins, unsaturated polyester resins, polyvinyl butyral resins, and alkyd resins.

Preferably, the polymer is a latex. The most preferred latices are copoly(styrene-butadiene) latices, (co)polyvinylester latices, and (co)polyacrylate latices. Further useful latices include aqueous baliphatic urethane dispersions; vinylacetate, and copolymers, such as copoly(vinylacetate-butylmaleate), copoly(vinylacetate-acrylate), copoly(vinylacetate-ethylene), and vinylacetate-vinylidenechloride; and copoly(acrylonitrile-butadiene). Also copolyester latices, e.g. sulphonated copolyester latices may be used.

The pigment containing layer preferably is much thicker than the top layer. Its wet thickness is preferably comprised between 20 and 200 μm, most preferably between 40 and 100 μm.

In a preferred embodiment the static surface tension of layer (b) is lower than the one of layer (a).

Depending on the surface properties of the substrate an extra adhesive layer may be applied between the support and the ink receiving layer (undercoat layer). This layer is then coated from an aqueous medium containing any of the numerous known adhesive polymers. Preferred adhesive polymers include an acrylate latex, such as ethylacrylate-hydroxyethylmethacrylate, poly(vinyl acetate) poly(ethylene-vinylacetate), polyvinylesters, copolyesters, and polyurethanes.

Layers (a) and (b) and the optional undercoat layer may further contain well-known conventional ingredients, such as surfactants serving as coating aids, hardening agents, plasticizers, whitening agents and matting agents.

Examples of surfactants are N-alkylamino acid salts, alkylether carboxylic acid salts, acylated peptides, alkylsulfonic acid salts, alkylbenzene and alkylnaphthalene sulfonic acid salts, sulfosuccinic acid salts, α-olefin sulfonic acid salts, N-acylsulfonic acid salts, sulfonated oils, alkylsulfonic acid salts, alkylether sulfonic acid salts, alkylallylethersulfonic acid salts, alkylamidesulfonic acid salts, alkylphosphoric acid salts, alkyletherphosphoric acid salts, alkylallyletherphosphoric acid salts, alkyl and alkylallylpolyoxyethylene ethers, alkylallylformaldehyde condensed acid salts, alkylallylethersulfonic acid salts, alkylamidesulfonic acid salts, alkylphosphoric acid salts, alkyletherphosphoric acid salts, alkylallyletherphosphoric acid salts, alkyl and alkylallylpolyoxyethylene ethers, alkylallylformaldehyde condensed polyoxyethylene ethers, blocked polymers having polyoxypropylene, polyoxyethylene polyoxypropylalkylethers, polyoxyethyleneether of glycolesters, polyoxyethyleneether of sorbitanesters, polyoxyethyleneether of sorbitolesters, polyethyleneglycol aliphatic acid esters, glycerol esters, sorbitane esters, propyleneglycol esters, sugaresters, fluoro C₂-C₁₀ alkylcarboxylic acids, disodium N-perfluorooctanesulfonyl glutamate, sodium 3-(fluoro-C₆-C₁₁alkyl-oxy)-1-C₃-C₄ alkyl sulfonates, sodium 3-(ω-fluoro-C₆-C₈ alkanoyl-N-ethylamino)-1-propane sulfonates, N-[3-(perfluorooctanesulfonamide)-propyl]-N,N-dimethyl-N-carboxymethylene ammonium betaine, fluoro-C₁₁-C₂₀ alkylcarboxylic acids, perfluoro C₇-C₁₃ alkyl carboxylic acids, perfluorooctane sulfonic acid diethanolamide, Li, K and Na perfluoro C₄-C₁₂ alkyl sulfonates, N-propyl-N-(2-hydroxyethyl)perfluorooctane sulfonamide, perfluoro C₆-C₁₀ alkylsulfonamide propyl sulfonyl glycinates, bis-(N-perfluorooctylsulfonyl-N-ethanolaminoethyl)phosphonate, mono-perfluoro C₆-C₁₆ alkyl-ethyl phosphonates, and perfluoroalkylbetaine.

Useful cationic surfactants include N-alkyl dimethyl ammonium chloride, palmityl trimethyl ammonium chloride, dodecyldimethylamine, tetradecyldimethylamine, ethoxylated alkyl guanidine-amine complex, oleamine hydroxypropyl bistrimonium chloride, oleyl imidazoline, stearyl imidazoline, cocamine acetate, palmitamine, dihydroxyethylcocamine, cocotrimonium chloride, alkyl polyglycolether ammonium sulphate, ethoxylated oleamine, lauryl pyridinium chloride, N-oleyl-1,3-diaminopropane, stearamidopropyl dimethylamine lactate, coconut fatty amide, oleyl hydroxyethyl imidazoline, isostearyl ethylimidonium ethosulphate, lauramidopropyl PEG-dimoniumchloride phosphate, palmityl trimethylammonium chloride, and cetyltrimethylammonium bromide.

Especially useful are the fluorocarbon surfactants as described in e.g. U.S. Pat. No. 4,781,985, having a structure of: F(CF₂)₄₋₉CH₂CH₂SCH₂CH₂N⁺R₃X⁻ wherein R is an hydrogen or an alkyl group; and in U.S. Pat. No. 5,084,340, having a structure of: CF₃(CF₂)ₘCH₂CH₂O (CH₂CH₂O)ₙR wherein m=2 to 10; n=1 to 18; R is hydrogen or an alkyl group of 1 to 10 carbon atoms. These surfactants are commercially available from DuPont and 3M. The concentration of the surfactant component in the ink-receiving layer is typically in the range of 0.1 to 2 %, preferably in the range of 0.4 to 1.5 % and is most preferably 0.75 % by weight based on the total dry weight of the layer.

The layers of the ink jet recording medium used in accordance with the present invention may be crosslinked to provide such desired features as waterfastness and non-blocking characteristics. The crosslinking is also useful in providing abrasion resistance and resistance to the formation of fingerprints on the element as a result of handling. There are a vast number of known crosslinking agents—also known as hardening agents—that will function to crosslink film forming materials.

Hardening agents can be used individually or in combination and in free or in blocked form. A great many hardeners, useful for the present invention, are known, including formaldehyde and free dialdehydes, such as succinaldehyde and glutaraldehyde, blocked dialdehydes, active esters, sulfonate esters, active halogen compounds, isocyanate or blocked isocyanates, polyfunctional isocyanates, melamine derivatives, s-triazines and diazines, epoxides, active olefins having two or more active bonds, carbodiimides, isoxazolium salts subsituted in the 3-position, esters of 2-alkoxy-N-carboxy-dihydroquinoline, N-carbamoylpyridinium salts, hardeners of mixed function, such as halogen-substituted aldehyde acids (e.g. mucochloric and mucobromic acids), onium substituted acroleins and vinyl sulfones and polymeric hardeners, such as dialdehyde starches and copoly(acroleinmethacrylic acid), and oxazoline functional polymers, e.g. EPOCROS WS-500, and EPOCROS K-1000 series.

When the element is intended for viewing in reflection, the ink-receiving layer of the invention may contain a whitening agent. TiO₂ (rutile or anatase) is preferably used as whitening agent.

The layers may also comprise a plasticizer such as ethylene glycol, diethylene glycol, propylene glycol, polyethylene glycol, glycerol monomethylether, glycerol monochlorohydrin, ethylene carbonate, propylene carbonate, tetrachlorophthalic anhydride, tetrabromophthalicanhydride, urea phosphate, triphenylphosphate, glycerolmonostearate, propylene glycol monostearate, tetramethylene sulfone, n-methyl-2-pyrrolidone, n-vinyl-2-pyrrolidone.

It is an essential feature of the present invention that layers (a) and (b) are coated simultaneouly wet on wet. When layer (b) is coated subsequently after coating and drying of layer (a) the problem of the occurence of cracks will not be solved. Preferably, a coating technique is used well-known from the manufacturing of photographic materials, such as slide-hopper (or cascade) coating, curtain coating and extrusion coating.

The support for use in the present invention can be chosen from the paper type and polymeric type support well-known from photographic technology. Paper types include plain paper, cast coated paper, polyethylene coated paper and polypropylene coated paper. Polymeric supports include cellulose acetate propionate or cellulose acetate butyrate, polyesters such as polyethylene terephthalate (PET) and polyethylene naphthalate, polyamides, polycarbonates, polyimides, polyolefins, poly(vinylacetals), polyethers and polysulfonamides. Other examples of useful high-quality polymeric supports for the present invention include opaque white polyesters and extrusion blends of polyethylene terephthalate and polypropylene. Polyester film supports, and especially polyethylene terephthalate, are preferred because of their excellent properties of dimensional stability.

Still further useful supports include wet strength paper, PVC, PVC with an adhesive backing, the polyethylene paper TYVEK, trade name of Du Pont Co., the porous polyethylene paper TESLIN, trade name of International Paper CO., canvas, polypropylene, and polycarbonate. The latter supports are especially useful when the ink jet recording element is meant for outdoor use.

The present invention will now be illustrated by the following examples without however being limited thereto.

### EXAMPLES

Preparation of a Coating Composition for layer (a)

A 1 liter dispersion was prepared containing 220 g of a commercially available silica (average particle size 6.5 μm), 330 g of a polyvinyl alcohol type (POVAL R3109, trade mark of Kuraray Co.), and 50 g of CATFLOC T2, a 40 % poly(diallyldimethylammonium chloride) aqueous solution, trade name of Calgon Co. The mixture was stirred with a high shear rotor stator mixer. To 843 ml of this dispersion 110 ml of AIRFLEX EPl, trade mark of Airflex Co., a 50 % ethylene-vinylacetate emulsion, was added and the mixture was stirred and diluted to 1 l with deionized water. The static surface tension was about 43 mN/m.

Preparation of Coating Compositions for layer (b)

The cationic surfactant cetyltrimethylammonium bromide (Merck Co.) together with a quantity of a water-soluble polymer according to table 1 hereinafter were added to deionized water and the mixture was diluted to 1 l.

TABLE 1

| | | | | | Static |
|---|---|---|---|---|---|
| | | | | | surface |
| | | | | | tension |
| No. | Trade name | Company | Chemical name | Quantity | mN/m |
| (b)1 | Catfloc T2 | Calgon | Polydiallyldimethylammonium | 500 ml | 35.0 |
| | | | chloride | | |
| (b)2 | Goshefimer | Nippon Goshei Cp | Vinylalcohol-vinylacetate- | 400 ml | 39.1 |
| | K210 8.5% | | diallyldimethylammonium | | |
| | solution in | | chloride copolymer = | | |
| | water | | cationic PVA | | |
| (b)3 | Celquat L200 | National Starch & | Cellulose 2-hydroxyethylether, | 300 ml | 37.6 |
| | 5% solution in | Chem. Corp | polymer with N,N-dimethyl, N,2 | | |
| | water | | propenyl-2 propene-1 | | |
| | | | ammoniumchloride | | |
| (b)4 | Mowiol 8/88 | Hoechst | Polyvinylalcohol-vinylacetate | 500 ml | 37 |
| | 15% solution in | | | | |
| | water | | | | |
| (b)5 | PB300 | Tessenderlo | Gelatine | 80 g | 37.4 |
| | | Chemie | | | |
| (b)6 | Metolose | Shin Etsu Company | Methylhydroxypropyl cellulose | 300 ml | 36.7 |
| | 65SH50 5% in | | | | |
| | water | | | | |

Coating of the Ink Jet Recording Media Samples

### Comparative Example 1

To the coating composition for layer (a) a small amount of the cationic surfactant cetyltrimethylammonium bromide (Merck Co.) was added and the composition was coated by slide-hopper coating on a polyester support at a wet thickness of 111 μm. The coating was dried at about 60° C. No second layer was coated.

A lot of cracks were detected visually. After ink jet printing with a HP720C the cracks were still present.

### Comparative Example 2

Layer (a) was coated as described above. In a second separate slide-hopper coating, layer (b)1 (see table 1) containing Catfloc T2 was coated at a wet thickness of 15 μm.

The cracks did not disappear by the separately coating of layer (b)1. They were still disturbing the outlook of the unprinted and printed sample.

### Invention Examples

The composition for layer (a) and the composition for layer (b)1 were coated simultaneously wet on wet by means of slide-hopper (cascade) coating at a wet thickness of 111 and 15 μm respectively.

No cracks could be detected visually. Even with a magnification of 20× no cracks were detected. Also the printed image was crack free.

The coating was repeated using the other compositions for layer (b) as indicated in table 1. A qualitative evaluation for the cracks is established ranging from 1 to 4:

4=extremely cracked

3=less cracking

2=minor cracking

1=no cracking

The qualitative evaluation is summarized in table 2

TABLE 2

| Coating composition | Evaluation cracks |
|---|---|
| (a)/no (b) (compar. Ex 1) | 4 |
| (a)/separate (b)1 (compar.ex 2) | 4 |
| (a)/(b)1 (inv.) | 1 |
| (a)/(b)2 (inv.) | 1 |
| (a)/(b)3 (inv.) | 2 |
| (a)/(b)4 (inv.) | 3 |
| (a)/(b)5 (inv.) | 1 |
| (a)/(b)6 (inv.) | 3 |

1. A method for the preparation of an ink jet recording element comprising coating on top of a support a layer pack comprising, in order, (a) a layer containing a pigment at a solid weight % of 60 to 98 of the total solid weight of the layer, and (b) a layer containing a water-soluble polymer, characterized in that said layers (a) and (b) are coated simultaneously wet on wet.

2. A method according to claim 1 wherein said pigment is an inorganic pigment.

3. A method according to claim 2 wherein said inorganic pigment is silica.

4. A method according to claim 1 wherein said polymer is a cationic polymer.

5. A method according to claim 4 wherein said cationic polymer is a nitrogen containing cationic polymer.

6. A method according to claim 5 wherein said cationic nitrogen containing polymer is poly(diallyldimethylammonium chloride).

7. A method according to claim 4 wherein said cationic nitrogen containing polymer is copoly(vinylalcohol-vinylacetate-diallyldimethylammonium chloride).

8. A method according to claim 5 wherein said cationic nitrogen containing polymer is cellulose 2-hydroxyethylether, polymer with N,N-dimethyl, N-2 propenyl-2 propene-1-ammoniumchloride.

9. A method according to claim 5 wherein said cationic nitrogen containing polymer is a polyamine.

10. A method according to claim 1 wherein the static surface tension of said layer (b) is lower than the static surface tension of said layer (a).

11. A method according to claim 1 wherein said layers (a) and (b) are coated simultaneously wet on wet by the slide-hopper coating technique.

12. A method according to claim 1 wherein said layers (a) and (b) are coated simultaneously wet on wet by the curtain coating technique.
